(19) United States
(12) Patent Application Publication
(10) Pub. No.: US 2004/0267661 A1
(43) Pub. Date: Dec. 30, 2004

(54) System and method for securitizing credit accounts

(76) Inventor: Adam Burczyk, Chicago, IL (US)

Correspondence Address: LADAS & PARRY LLP, 224 SOUTH MICHIGAN AVENUE, SUITE 1200, CHICAGO, IL, 60604, US

(21) Appl. No.: 10/491,678

(22) PCT Filed: Oct. 15, 2002
(86) PCT No.: PCT/US02/32928

Related U.S. Application Data
(60) Provisional application No. 60/328,949, filed on Oct. 12, 2001.

(51) Int. Cl. G06F 17/60

(52) U.S. Cl. 705/40; 705/35

(57) ABSTRACT

A method and system, which can be automated or computerized, via a computer network, that allows outside investors to serve as originators of credit funds to credit users, in a competitive “offering” environment, where the funds are nonetheless channellled through, and serviced by, the administrative infrastructure of a credit servicer, like a traditional bank or financing company, who continues to cultivate the customer relationship.

### FIELD OF THE INVENTION

The present invention relates to a method and system, which can be automated or computerized, via a computer network, that allows outside investors to serve as originators of credit funds to credit users, in a competitive “offering” environment, where the funds are nonetheless channelled through, and serviced by, the administrative infrastructure of a credit servicer, like a traditional bank or financing company, who continues to cultivate the customer relationship.

### BACKGROUND OF THE INVENTION

The traditional underwriters of credit obligations, like banks, credit card issuers, and financing companies, typically combine the dual roles of credit administration and credit origination. Usually only one of these two roles, is more suited to the strength, or core competence, of the underwriter. For example, in the competitive arena of consumer credit cards, some card issuers are very good at identifying, soliciting, and securing credit relationships with individual consumers, but have a high cost of capital. Other card issuers have a very low cost of capital, but are not so good at building, maintaining, and expanding consumer credit relationships.

At the same time, investors often face diminishing positive returns, or outright losses, from their investments in various securities, futures, derivatives, and other liquid financial instruments. Traditional investment vehicles, like stocks, bonds, commodities, and securities can go up and down in value together, in tandem with a boom-and-bust business cycle. But when these traditional investment vehicles go down in value together, investors cannot easily find other investment vehicles, whose attractive returns are not attached to the business cycle. For example, there are very few investment vehicles for outside investors that have attractive returns that are attached to the risks of funding credit cards.

At the same time, traditional underwriters of credit origination want to relieve themselves of the risk of repayment delay, delinquency, or default from select parts of their overall exposure, and thereby free up a select portion of “backup capital,” held as reserves, and redeploy this capital for more productive purposes.

Further, traditional credit users wish to gain access to credit that is cheap and convenient to utilize, and remain indifferent as to whether outside investors or the traditional underwriters are actually originating the funds for their use. As long as anonymity is maintained with respect to their identity or identifying characteristics, most credit users are indifferent about outside investors scrutinizing their risk factors or general traits of credit history.

Thus, the prior art has no method or system to produce an investment vehicle that solves all of the above financial problems, simultaneously, in the following ways: firstly, enabling lower cost of capital, or, no cost of capital, to the credit underwriters; secondly, providing higher returns for risks borne by outside investors; thirdly, providing cheap and convenient lines of credit to credit users.

### SUMMARY OF THE INVENTION

Accordingly, it is one object of the present invention to provide capital relief, that is, relief from the costs of capital and the related prospect of capital loss, to credit underwriters experiencing a high cost of capital, by providing a way for outside investors to substitute their funds for those of the underwriters. Such a substitution reduces the cost of capital to zero, the risk of default to zero, and the need for reserves to zero, for those credit underwriters.

Under this invention, the traditional functions of underwriting selection, credit restriction, credit approval, and payment tracking of credit-user accounts may remain within the administration infrastructure of a credit servicer. But the capital at risk is provided by outside investors, who examine, via data mining, the credit history, risk factors, and underwriting specifications of each prospective credit user, except for characteristics of identification. The outside investors then offer to the credit servicer, competitive lines of credit, to be used by the unidentified, but aliased, credit user.

Because the credit servicer has not provided its own money to the credit user, the credit servicer is relieved of the task of financial underwriting, and fully relieved of the risk from delays, delinquencies, or defaults of repayment. The outside investors are now the holders of credit risk. A credit servicer has no further prospect of losing money from any future delays, delinquencies, or defaults of repayment. There is no need for the credit servicer to keep reserves against defaults. Defaults are suffered only by the outside investors who provided the credit in the first place.

The credit servicer can gain an administration fee, whose particulars can be negotiated between the outside investor and credit servicer. For example, a credit servicer of credit cards can obtain an administration fee from a fraction from an overall positive inflow of finance charges and fees collected from the credit card user. Continuing this example, a credit servicer might not get any administration fee when the finance charges and fees are not forthcoming, or when the credit user has defaulted on repayment of the utilized credit.

Accordingly, it is another object of the present invention to provide outside investors, with the potential for higher returns, after losses from defaults, than would otherwise be obtained with traditional financial instruments during a business cycle downturn.

For example, outside investors can obtain an investor fee from a fraction of an overall positive inflow of finance charges and fees collected from the credit card user. Continuing this example, the administration fee and investor fee are split in some contracted proportion by the credit servicer and outside investor, so that both have economic incentives to continue their respective activities either administrating, or originating, credit to the card user.

The outside investors, credit servicers, and credit users in this invention are participants in what is called a securitized payable financial instrument, where the outside investors are obligated to provide the necessary funds to the credit user, via the administration of the credit servicer, when the credit user decides to utilizes the credit.

By using the securitized payable financial instruments enabled by this invention, outside investors can earn higher returns, after adjusting for risks, on their investment funds than what would normally be available through conventional investment vehicles, like stocks, bonds, currencies, or commodities. This is because selective funding of credit accounts, via the securitized payable instrument, can be relatively profitable during business cycles where stocks, bonds, currencies, or commodities only provide lower returns, after adjusting for risks.

For example, an outside investor in securitized payable financial instruments for credit cards, may obtain higher returns, after adjusting for risks, compared to stocks, bonds, currencies, or commodities, or, even compared to securitized receivables, during a downturn in the business cycle while consumer spending is strong and delinquencies or defaults remain low.

Finally, it is another object of the present invention to provide credit users, with a useful opportunity to obtain cheap and convenient forms of credit, via outside investors who can provide cheaper and more convenient forms of credit.

### BRIEF DESCRIPTION OF THE DRAWINGS

FIG. 1 is a flow chart of the creation of the three roles (outside investors, credit servicer, and one or more credit users) that are related to each other in the method and system of securitized payable accounts.

FIG. 2 is a flow chart showing how a credit servicer accepts a credit user for an extension of credit, but then posts relevant information about the credit account to outside investors, so they can review relevant information about the credit account.

FIG. 3 is a flow chart showing how outside investors offer various amounts of money to the credit servicer, at various rates of interest, to fund the extension of credit to the credit user, via the administration of the credit servicer.

FIG. 4 is a flow chart showing how the credit user utilizes the extension of credit, and then redeems outstanding credit obligations to the credit servicer, who then splits, or divides, the redemptions with the outside investors, according to an agreed method of distribution.

### DETAILED DESCRIPTION OF THE PREFERRED EMBODIMENT

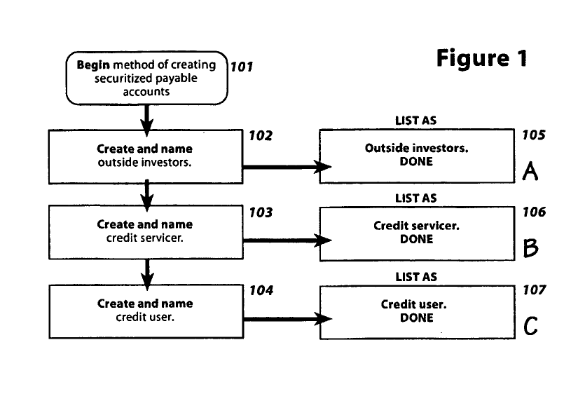

The invention is a computer-implemented method, and computer-readable medium whose preferred embodiment begins with FIG. 1, step 101, where a method to create securitized payable accounts starts with creating the three roles of outside investors, credit servicer, and credit user.

The result of the overall method and system of the invention, is a securitized payable account, where the origination and finding of a significant portion of credit to a credit user is from outside investors. The outside investors have established payable obligations to the credit servicer, to fund the utilized extensions of credit to the credit user, in exchange for a significant portion of the redemptions that are above and beyond those available in securitized receivables. The securitization is based on the fact that the outside investors have “secured” a specified portion of redemptions that may be paid back by a specific credit user to the credit servicer. A securitized payable may be based on the redemptions of a single credit user, or, as with securitized receivables, wholly based on a pooled, undifferentiated, group of credit users.

Moving from step 101 to step 102 to step 105, outside investors are identified and named so that they may serve the process and purpose of the overall method and system of the invention. An outside investor may be an individual, but is usually a business or government agency. The role of outside investors is created and listed with Transition Box labelled A. A Transition Box will be used to end one Figure page, and to begin the next Figure page.

Moving from step 101 to step 103 to step 106, the credit servicer is also identified and named so that he, she, or it may serve the process and purpose of the overall method and system of the invention. A credit servicer can be an individual, but typically is a business, like a bank or financial institution, or, a government agency. The role of credit servicer is created and listed with Transition Box labelled B.

Moving from step 101 to step 104 to step 107, the credit user is also identified and named so that he, she, or it may serve the process and purpose of the overall method and system of the invention. A credit user can be an individual, business, or government agency. The role of credit user is created and listed with Transition Box labelled C.

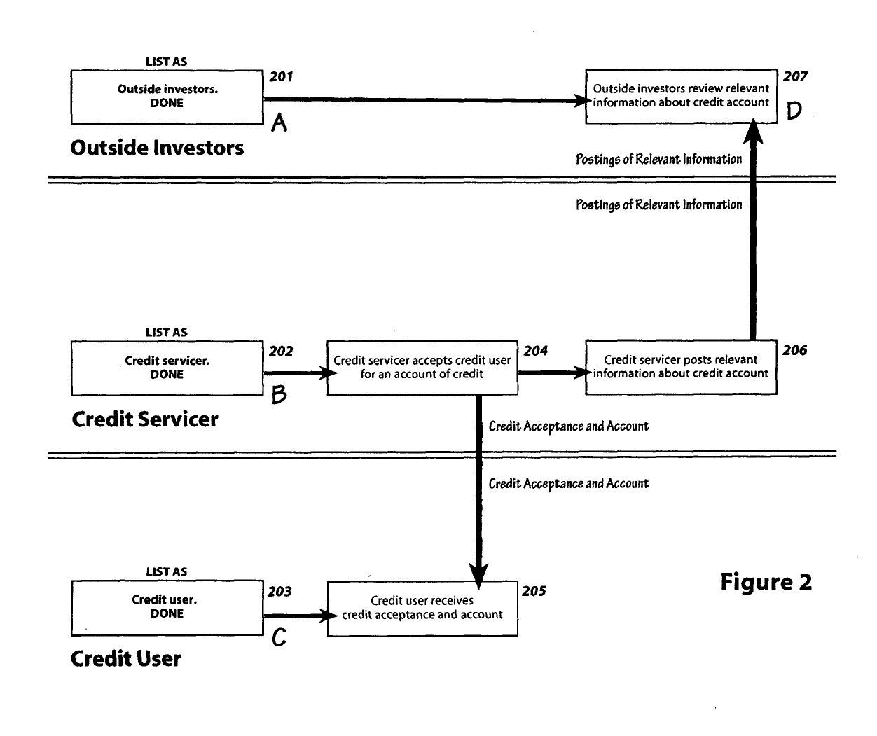

Moving from FIG. 1 to FIG. 2, the outside investors, credit servicer, and credit user are now divided by double lines into their own respective domains, so that their interactions, as prescribed by the invention, are explained more effectively. The credit servicer is an intermediary between the outside investors and the credit user. Indeed, the outside investors and credit user do not need to be aware of each other's identities, or roles, in the process of the invention.

In FIG. 2, respective domains of outside investors, credit servicer, and credit user, are established with their listings in the respective steps 201, 202, and 203. These steps are the respective Transition Boxes A, B, and C, from the previous FIG. 1.

From steps 201, 202, and 203, the next step is 204, where the credit servicer accepts a credit user for an account of credit. A credit servicer can be a traditional bank or financial institution, whose administrative infrastructure and servicing apparatus in soliciting, securing, and servicing credit accounts to credit users will allow it to earn revenues from the securitized payable account, without needing to put up its own money as part of the extension of credit.

The credit acceptance and account is provided to the credit user, via the crossing arrow between step 204 and 205, so that the credit user receives the credit acceptance and account in step 205. The credit servicer now posts the relevant information about the credit account, step 206, to outside investors. Postings of relevant information are passed to outside investors, via the crossing arrow between step 206 and 207. The outside investors now review the relevant information about the credit account, step 207, to determine whether, and how much, and at what rate, they should find the extension of credit to the ultimate credit user, through the credit servicer. Outside investors may use their own investment criteria, or risk management models, to determine whether to offer money to the credit servicer, to fund the extension of credit to a specific credit user.

In the preferred embodiment of the invention, a bulletin board, or electronic display, or computerized database, of relevant information of the credit users, can be provided to the outside investors, so that the outside investors can perform analytic tasks, and weigh credit lending decisions. The credit histories, risk factors, underwriting specifications, and other relevant circumstances can be provided in such a way so that outside investors can know and understand their relative risks and rewards in the securitized payable relationship. In contrast to securitized receivables, securitized payables allow for outside investors to cherry-pick those credit users that provide the best prospect for risks and rewards for their moneys. Investing in a discretionary portfolio of securitized payables, based on cherry-picked credit users, may provide higher financial returns than investing in securitized receivables, whose collateral is comprised of a forced pool of undifferentiated credit users.

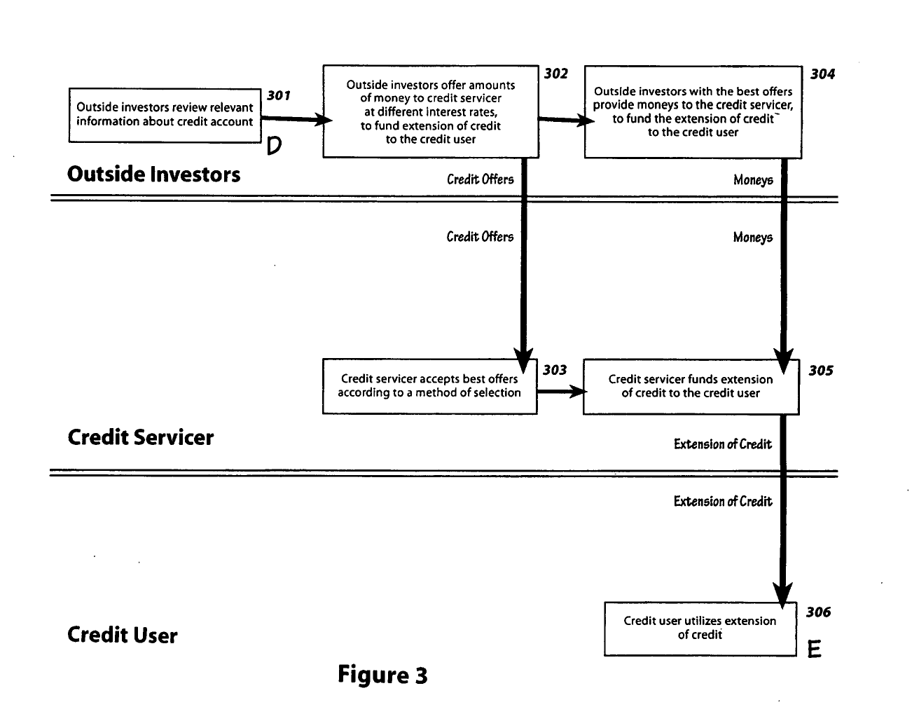

Turning now to FIG. 3, outside investors at step 301, Transition Box D, have completed their review of relevant information about the credit account. Moving to step 302, outside investors now offer amounts of money to the credit servicer at different interest rates, to fund the extension of credit to the credit user.

In the preferred embodiment, the credit servicer can create a special conduit, or trust corporation, to serve as the beneficial holder of moneys provided from the outside investors to the credit users. In this way, the moneys transferred from the outside investors are not held by the credit servicer, but by the conduit, or trust, so that the credit servicer does not benefit from, or suffer from, the impact of new investment funds, on its balance sheet.

Also, in the preferred embodiment, outside investors can competitively offer different amounts of money, at different interest rates, to fund the extension of credit to the credit user. For example, Outside Investor A may offer $5000 at 8% to the credit servicer, and Outside Investor B may offer $5000 at 11% to the credit servicer, to fund the same extension of credit to the credit user. The credit servicer may then accept the offer it considers to be more optimal to its own financial interests, by accepting the cheaper rate, 8%, and passing on some, but not all, of the cheaper rate to the credit user, say 9%, keeping the 1% for itself.

Under the method, the credit servicer accepts the best offers according to a method of optimal selection. The method of optimal selection can vary. For example, the credit servicer may decide to accept the largest offers of money by amount, regardless of the interest rate. Or, the credit servicer may decide to accept the offers with the lowest interest rates, regardless of amounts of money. Or, the credit servicer may decide to accept the offers that are pre-provided, before any prospective utilization of the credit by the credit user. Or, the credit servicer may decide to accept the offers that provide the largest administration fee to the credit servicer. The method of optimal selection can be determined by any combination of credit servicers, outside investors, or credit users, alone or as a group, or, by an contracting agent among them.

Also, in the preferred embodiment, a competitive auction may take place electronically among different investors, to allow them to re-calibrate their own offers of moneys, and help them maximize their returns and minimize their risks.

Credit offers are passed from the outside investors to the credit servicer, via the crossing arrow between step 302 and 303. In step 303, the credit servicer accepts the best offers according to a method of selection. This method of selection can optimize the risks, rewards, or administrative efficiencies of the credit servicer, outside investors, or the credit user. For example, a credit servicer may wish to maximize the availabilities of funds to the credit user, so the credit servicer may select those credit offers that are largest in size, regardless of their specified rates of interest, as long as the credit user is believed able, willing, and ready to redeem at those specified rates, or at rates that are marked up from those specified rates.

The preferred embodiment of the invention uses a computerized selection method that sifts through various “cyberoffers” from outside investors, to provide the best deal either for the credit servicer, or, for the credit user, or both.

Moving from step 303 to step 304, the accepted offers of the outside investors are now provided to the credit servicer. In step 304, the outside investors with the best offers provide moneys to the credit servicer, to fund the extension of credit to the credit user.

Under the method, the outside investors with the best offers then provide the moneys, or promise of moneys, to the credit servicer, to fund the extension of credit to the credit user. These moneys can either be pre-provided to the credit servicer, before the prospective utilization of funds by the credit end-user, or, alternatively, post-provided to the credit servicer, that is, after the actual utilization of funds by the credit end-user. In either scenario, the credit servicer is relieved of the risk of losing money from any delay, delinquency, or default of repayment by the credit user.

Moneys are passed from the outside investors to the credit servicer, via the crossing arrow between step 304 and 305. In the preferred embodiment, the credit servicer has a conduit or trust that serves as the beneficial holder of moneys from investors, whose moneys the credit servicer will either fund, cause to fund, extend, or cause to extend, to the credit user.

At step 305, the credit servicer funds, or causes to fund, an extension of credit to the credit user. In the preferred embodiment, the credit servicer causes to fund, via the conduit or trust, the extension of credit to the credit user. An extension of credit is passed from the credit servicer to the credit user, via the crossing arrow between step 305 and 306. The credit user now utilizes the extension of credit, at step 306, Transition Box E.

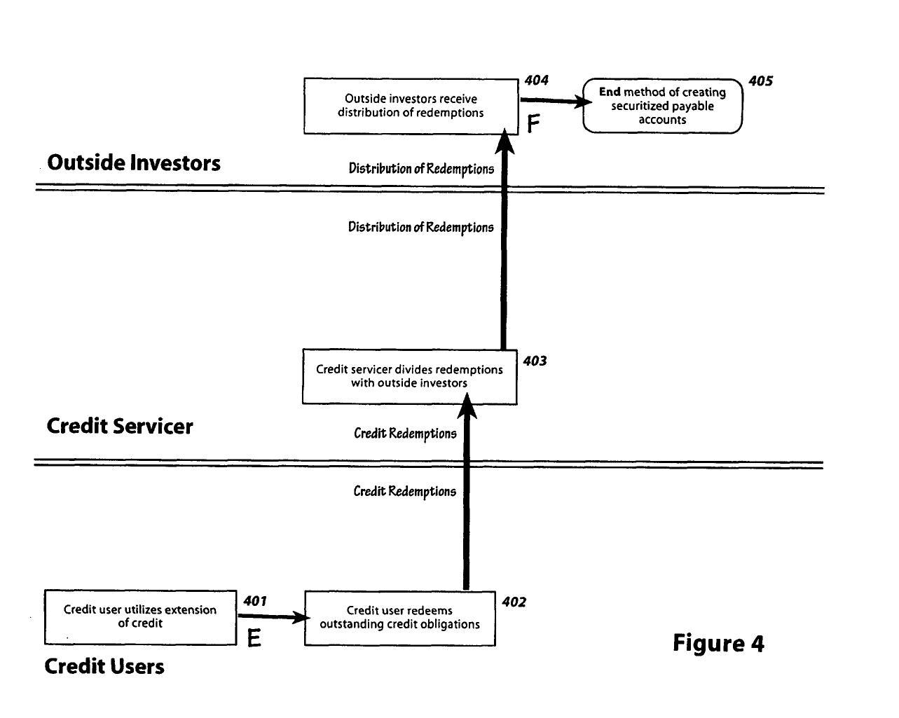

Turning now to FIG. 4, the credit user utilizes the extension of credit, at step 401, Transition Box E. The credit user then redeems outstanding credit obligations to the credit servicer, step 402. The credit user, of course, may never redeem those obligations on time, or in full, or both, which is the essence of credit risk. The holders of the credit risk are the outside investors who have provided moneys for the extension of credit to the credit user. These outside-investor moneys may be temporarily impaired, that is, late or partial in payment, or, alternatively, permanently lost. In contrast to the outside investors, the credit servicer has provided no moneys that can be potentially lost due to delays, delinquencies, or defaults in credit redemption. The credit servicer only incurs losses from the infrastructure costs of administrating over such so-called non-performing accounts.

In the preferred embodiment, the changing statuses of securitized payable risks are continuously available electronically to the outside investors, via a computer network, so they can recalibrate their portfolios of credit users, and recalibrate their offerings, and rates of interest, to prospective credit users.

Credit redemptions are passed from the credit user to the credit servicer, via the crossing arrow between step 402 and 403. Again, in the preferred embodiment, the credit servicer may have a conduit, or trust, beneficially receiving these credit redemptions on behalf of the outside investors. The credit servicer then divides these redemptions with the outside investors, according to a method of division, or what the financial industry calls “distribution.” In the preferred embodiment, the credit servicer and outside investors split, according to a ratio, any finance charges and fees that are above and beyond those moneys provided by the outside investors as underlying principal. To complete an earlier example, an outside investor may have provided $5000 at 8%, and has agreed to split this 8% with the credit servicer according to a ¾ ratio. After receiving back the $5000, the outside investor also gets 6% back, with the remaining 2% going to the credit servicer. But the credit servicer also may receive the additional 1% it has charged to the credit user, for a total of 3%, just for servicing the account. This 3% can be a good return for the credit servicer, especially when the only costs the credit servicer suffers are from servicing the account.

The distribution of redemptions are passed from the credit servicer to the outside investor, via the crossing arrow between step 403 and 404. The outside investors now receive the distribution of redemptions, which can include a fraction of finance charges and fees above and beyond the value of the provided moneys, step 404, Transition Box F. Under the preferred embodiment, the method of distribution is provided via a financial computer network, via electronic settlements and wire transfers. The method of creating securitized payable accounts is now ended, step 405.

The method of distribution can vary. For example, the credit servicer may decide to split the redemptions with the outside investor according to a ratio. Or, the credit servicer may decide to accept only a portion of the interest payments and fees that are associated with the credit extension, and give the remaining portion, with the principal, back to the outside investors. The method of distribution can be determined by any combination of credit servicers, outside investors, or credit users, alone or as a group, or, by an contracting agent among them.

In variations of the preferred embodiment, the outside investors may pre-provide the moneys that are to be used by the credit user, before the credit user utilizes them. The extension of credit is made, as in FIG. 3, step 305, and in the extension of credit passed from the credit servicer to the credit user, via the crossing arrow between step 305 and 306, but the credit user delays, or never fully utilizes, the extension of credit.

In variations of the preferred embodiment, the outside investors may promise the moneys that are to be used by the credit user, before the credit user utilizes them. The promise of extension of credit is made, as in FIG. 3, step 305, and in the extension of credit passed from the credit servicer to the credit user, via the crossing arrow between step 305 and 306, but until the credit user utilizes, the extension of credit, the outside investors do not provide the moneys, as in step 304.

In variations of the preferred embodiment, the outside investors may obtain financial derivatives whose potential liabilities to provide the moneys for the extension of credit, are triggered by the credit user utilizing that extension of credit. The commitment of contingent credit is made, as in FIG. 3, step 304, and in the extension of credit passed from the credit servicer to the credit user, via the crossing arrow between step 305 and 306, but only when the credit user utilizes the extension of credit, as in step 304.

Credit users do not need to be aware that this invention, or securitized payable financial instruments enabled by this invention, are providing them with cheaper and more convenient forms of credit. Individual credit users can be anonymized, and aliased, so that their identities, and any identifying characteristics, are removed from the financially relevant information reviewed by outside investors. At the same time, the outside investors themselves can be anonymized, and aliased, so that their identities, and any identifying characteristics, are removed from the relationship between the credit servicer and credit user.

While the present invention has been particularly described, in conjunction with the specific preferred embodiment, it is evident that many alternatives, modifications, and variations will be apparent to those skilled in the art in light of the foregoing description. It is therefore contemplated that the appended claims will embrace any such alternatives, modifications, and variations, as falling within the truth, scope, and spirit of the present invention.

What is claimed is:

1. A method and system of securitizing credit accounts, comprising the steps of:
a) creating and naming outside investors,
b) creating and naming at least one credit servicer,
c) creating and naming at least one credit user,
d) accepting, by the credit servicer, of a credit user,
e) posting, by a credit servicer, of relevant information,
f) reviewing, by outside investors, of relevant information from the credit servicer,
g) offering, by the outside investors, of different amounts of money,
h) accepting, by the credit servicers of the best offers of money.

2. The method of claim 1, wherein the steps are computerized.

3. The method of claim 1, wherein the credit servicer and the outside investors are connected by means of a computer network.

4. The method of claim 3, wherein the credit user is connected by means of a computer network.

5. The method of claim 1, wherein the credit user is selected from the group consisting of individuals, businesses and governments.

6. The method of claim 1, wherein the credit servicer is selected from the group consisting of individuals, businesses and governments.

7. The method of claim 1, wherein the outside investor is selected from the group consisting of individuals, businesses and governments.

8. The method of claim 1, further including the step of the credit user utilizing the extension of credit.

9. The method of claim 8, further including the step of the outside investors providing moneys to the credit server before the credit user utilizes the extension of credit.

10. The method of claim 8, further including the step of the outside investors promising moneys to the credit servicer only upon the credit user utilizing the extension of credit.

11. The method of claim 8, further including the step of the outside investors obtaining financial derivatives that are potential liabilities to the credit servicer only upon the credit user utilizing the extension of credit.

12. The method of claim 8, further including the step of the credit user redeeming outstanding obligations based on the utilized extension of credit, in payments to the credit servicer.

13. The method of claim 8, further including the step of the credit servicer dividing the redemptions of outstanding obligations with the outside investors according to a method of distribution.

14. The method of claim 13, further including the step of the credit servicer creating a trust to beneficially hold moneys that may be transferred, extended, or redeemed between the credit user and outside investors.
